(19) United States
(12) Patent Application Publication
(10) Pub. No.: US 2010/0081006 A1
(43) Pub. Date: Apr. 1, 2010

(54) FAUX STAINLESS STEEL FINISH ON BARE CARBON STEEL SUBSTRATE AND METHOD OF MAKING

(75) Inventors: Richard M. Leidolf, Jr., Canfield, OH (US); Daniel C. Leas, Rootstown, OH (US); Joseph D. Corona, Baden, PA (US)

Correspondence Address: CARELLA, BYRNE, CECCHI, OLSTEIN, BRODY & AGNELLO, 5 BECKER FARM ROAD, ROSELAND, NJ, 07068, US

(73) Assignee: MAIN STEEL POLISHING COMPANY, INC., Tinton Falls, NJ (US)

(21) Appl. No.: 12/417,803

(22) Filed: Apr. 3, 2009

Related U.S. Application Data
(60) Provisional application No. 61/052,338, filed on May 12, 2008.
(60) Provisional application No. 61/101,728, filed on Oct. 1, 2008.

(51) Int. Cl. B32B 15/18; B24B 1/00; B24B 21/04; B32B 15/08; B32B 15/01; B05D 3/12

(52) U.S. Cl. 428/687; 451/59; 451/297; 428/457; 427/292

(57) ABSTRACT

A faux stainless steel sheet material of ferrous carbon sheet steel core is polished in a polishing apparatus comprising a series of commercially available polishing heads each of which utilizes a polishing belt of a predetermined grit mesh and size, belt speed, belt oscillations transverse to the sheet steel conveyed direction, at predetermined conveyance rate of the sheet steel and pressure. The polishing heads scratch the material surface wherein the scratches mimic a stainless steel finish such as #4 stainless steel finish (80 mesh). An example and sample are described in one embodiment of the invention.

This application claims the benefit of provisional applications Ser. Nos. 61/052,338 filed May 12, 2008 and 61/101,728 filed Oct. 1, 2008 both incorporated in its entirety herein.

This invention relates to providing a finish to the surface of a carbon ferrous sheet steel substrate that visually appears to be stainless steel and a method of making.

### CROSS REFERENCE TO RELATED APPLICATION

Of interest is commonly copending U.S. application Ser. No. 11/221,300 entitled Faux Stainless Steel filed Sep. 7, 2005 assigned to the assignee of the present invention and also to ISG (International Steel Group).

Currently stainless steel for architectural applications, medical equipment, food industry equipment, vehicles, sanitary equipment, household appliances and so on is in wide use. Such finishes for household appliances and so on such as refrigerators, dishwashers, washing machines, ovens and the like are becoming popular and also are becoming widespread in use. Other finishes for such appliances typically are enameled and in some cases are finished in front with simulated wood grain panels and the like. Such finishes typically include enamel or other paint like finishes, which are less costly than stainless steel and are in wide use. One type of finish is a relatively low cost plastic laminate that simulates stainless steel for home appliance use. The problem with stainless steel material for such uses is its relatively higher cost.

Carbon steel sheet presently may be polished and provided with a coating to protect it from corrosion. The carbon ferrous sheet steel may be an iron substrate with carbon added. The coating on the polished sheet steel may be a clear polymer or a metal coating, sometimes referred to as galvanized, or a combination thereof, as commercially available to protect the steel sheet from corrosion. Such carbon steel coatings may include zinc and aluminum, or zinc, aluminum, silicon, iron and titanium or zinc and nickel alloys. The metal coating is then finished with a clear coating. The clear coating is a polymer and protects the coated finish. This coated sheet material is less costly than stainless steel, but does not have the same high quality look and appearance of stainless steel.

The above-noted copending application discloses a carbon steel or other base material, preferably metal, but whether or not steel, that has metal coating as described above that is polished to simulate a stainless steel finish, but not the cost. The coating is polished with one or more grit belts and the polished material is then coated with the clear polymer coating. Such a non-stainless steel metal finished product is intended to provide lower cost, but provide a quality appearance to various consumer goods such as the appliances and other goods as described above. However, the present applicants recognize a need for even lower cost simulated stainless steel product wherein the metal coating is eliminated. It is not known in the metals industry that conventional sheet carbon steel can or could be finished to have the appearance of stainless steel. This gives rise to the need in the prior art to provide a metal coating of the types described above which was then polished to simulate the SS finish.

U.S. Pat. No. 7,125,613 to Tullis et al. also describes a polished metal coated ferrous CRS substrate, having a metal coating of Zn—Ni alloy similar to those described in the above noted copending application and which is further protected with a PVC, polyester, acrylic or epoxy coating.

U.S. Pat. No. 6,440,582 to McDevitt discloses an abraded polished finish on a coated CRS ferrous substrate that is intended to simulate stainless steel. The coating is abraded by abrasive brushes. However, this material was not commercially successful as the finish that was produced by the abrasive brushes was not commercially reproducible as a satisfactory replica of stainless steel.

U.S. Pat. No. 5,049,443 to Kuszaj et al. discloses a steel multi-layered composite molded structure. This is disclosed as a plastic backed enameled carbon steel or stainless steel finish product that has high impact, delamination and thermal shock resistance. The composite is formed of carbon steel or stainless steel and thus does not solve the problem noted above when using stainless steel. The carbon steel or stainless steel has a finish side of a shell layer of reinforced plastic bonded directly to the steel using silane to form a laminated structure. This patent is not directed to providing a substitute for the more costly stainless steel material and in fact may use such material in its structure.

U.S. Pat. No. 6,770,384 to Chen discloses an article coated with a multi-layer decorative and protective coating having the appearance of stainless steel. The coating comprises a polymer basecoat layer on the surface of the article and vapor deposited at a relatively low pressure on the polymer layer. A protective and decorative color layer comprises the reaction products of refractory metal or refractory metal alloy, nitrogen and oxygen wherein the nitrogen and oxygen content of the reaction products are each from about 4 to about 32 atomic percent with the nitrogen content being at least about 3 atomic percent.

US Publ. No. 2005/0040138 to Sato et al. discloses a surface finishing process for stainless steel where beautiful, bright and milky white colored surfaces are obtained for high carbon-containing 13 chromium steel and high sulfur-containing free cutting stainless steel. The surface is descaled first and then immersed into treating solutions. This process thus enhances stainless steel, but does not provide a substitute material that looks like stainless steel but does not have its cost.

U.S. Pat. No. 6,203,403 to Odstrcil et al. discloses a method for polishing stainless steel laminate press plates to produce a nondirectional, high gloss surface. This patent is not relevant to the problem of providing a low cost material that appears to have the finish of stainless steel.

a ferrous carbon steel sheet material substrate; and

A faux polished stainless steel sheet according to an embodiment of the present invention comprises a carbon ferrous sheet steel substrate, and an abrasive particle grit polished finish on the exterior surface of the sheet steel substrate, which finish simulates polished stainless steel.

In one embodiment, a protective coating is on the sheet steel substrate which coating permits the polished surface to be visible.

In a further embodiment, the polished surface has a roughness in the range of 10-20 RA, scratches having a length of about 9.54 to 12.7 mm (⅜ to ½ inches) and a reflectivity of about 80 to about 115 gloss units across the scratches and about 100 to about 170 gloss units parallel to the scratches gloss units, where a gloss unit is the ratio of light specularly reflected to the total light reflected wherein specularly reflected light is one wherein the angle of incidence equals the angle of reflection.

In a further embodiment, the polished surface has a reflectivity in a range of about 80 to about 115 gloss units across the scratches and about 100 to about 170 gloss units parallel to the scratches gloss units wherein a gloss unit is the ratio of light specularly reflected to the total light reflected wherein specularly reflected light is one wherein the angle of incidence equals the angle of reflection.

Preferably, the surface has scratches having a length of about 9.54 to 12.7 mm (about ⅜ to ½ inches).

In a further embodiment, the polished grit abraded surface of the carbon steel substrate has a surface roughness in the range of 10-20 RA.

In a further embodiment, the polished carbon steel substrate finish has the appearance of a commercially defined abraded stainless steel finish comprising 80 mesh wherein the term mesh refers to an abrasive polishing belt grit value.

A method of producing a faux stainless steel sheet according to an embodiment of the present invention comprises polishing a carbon ferrous sheet steel substrate to produce a surface finish with an abrasive particle grit to mimic a stainless steel finish.

In one embodiment the polished sheet substrate is coated with a protective coating such as a polymer or the like wherein the polished stainless steel finish is visible through the coating.

In a further embodiment, the polishing step comprises forming scratches in the surface with scratches having a length of about 9.5 to 12.7 mm (about ⅜ to ½ inch).

In a still further embodiment, the polishing step comprises polishing the surface to a reflectivity in the range of about 80 to about 115 gloss units across the scratches and about 100 to about 170 gloss units parallel to the scratches gloss units wherein a gloss unit is the ratio of light specularly reflected to the total light reflected wherein specularly reflected light is one wherein the angle of incidence equals the angle of reflection.

In a further embodiment, the polishing step comprises engaging a Si carbide particle loaded grit belt with the surface in transverse oscillations having an amplitude of about 6.35 mm (¼ inch) at 45 cycles per minute and at a sheet material feed rate of about 25.908-32 m/min (85-105 f/min).

In a further embodiment, the polishing comprises forming an appearance of a commercially defined abraded polished stainless steel finish with a Si carbide particle loaded grit belt comprising about 80 mesh wherein the term mesh refers to the belt grit value.

In a further embodiment, the method comprises providing the surface with a surface roughness of about 10-20 RA.

In a further embodiment, the polishing includes coating the polished substrate with a polymer coating to protect the underlying substrate from corrosion wherein the polished finish is visible through the coating.

In a further embodiment, the method comprises forming the substrate at about 0.635 mm (0.025 Inches) thick.

In a further embodiment, the polishing step comprises removing up to about 0.0127 mm (0.0005 inches) of material from the substrate thickness.

### IN THE DRAWING

FIGS. 1a and 1b together form a schematic diagram of a polishing line of a coil to coil polisher apparatus for polishing coiled sheet metal, FIG. 1b being a continuation of FIG. 1a at regions I-I;

FIG. 1c is a fragmented sectional elevation view of a polymer coated carbon ferrous sheet steel substrate after polishing;

FIG. 2 is a more detailed elevation view of a representative polishing head using a two roll polishing configuration employed in the polishing line of FIGS. 1a and 1b;

FIG. 3 is a fragmented side elevation view of a contact roll used in the apparatus of FIGS. 1a and 1b;

FIGS. 4a and 4b are graphs useful for explaining certain principals of the present invention;

FIG. 5 is a 50× magnification photograph illustrating the grinding grooves produced on the substrate on the left, center and right side portions of the polished surface of the bare carbon steel substrate polished to simulate stainless steel wherein the length dimension of the coil of the substrate extends from the drawing bottom to the top of the figure;

FIG. 6 illustrates a top plan diagrammatic view of a sample of the carbon steel substrate (referred in this art as mild steel) 12.25 inches (31.1 cm) by 12.25 inches (31.1 cm) divided into 9 sections and referred to in the graphs of certain of the figures;

FIG. 7 is a graph illustrating the total, diffused and specular reflections across the polished face of the carbon steel substrate;

FIG. 8 is a graph illustrating the total reflection at different sections of the polished face of the carbon steel substrate of FIG. 6;

FIG. 9 is a graph illustrating the diffused reflection at different sections of the polished face of the carbon steel substrate of FIG. 6;

FIG. 10 is a graph illustrating the specular reflection at different sections of the polished face of the carbon steel substrate of FIG. 6;

FIG. 11 is a graph illustrating the average total, diffused and specular reflectivity at different sections of the polished face of the carbon steel substrate;

FIG. 12 illustrates a chart manifesting the standard deviation for total, diffused, and specular reflectivity of the carbon steel substrate;

FIG. 13 is a graph illustrating the average total reflectance of the polished face of the carbon steel substrate as compared to stainless steel;

FIG. 14 is a graph illustrating the average diffused reflectance of the polished face of the carbon steel substrate as compared to stainless steel;

FIG. 15 is a graph illustrating the average specular reflectance of the polished face of the carbon steel substrate as compared to stainless steel;

FIG. 16 is a graph illustrating the diffused total reflectivity of the polished face of the carbon steel substrate as compared to stainless steel;

FIG. 17 is a graph illustrating the specular reflectivity as a % of the total reflectivity of the polished face of the carbon steel substrate;

FIG. 18 is a photograph at 500× magnification of the cross section of the stainless steel sample referred to in the various other figures;

FIG. 19 is a top plan view of the polished stainless steel sample referred to in the various other figures; and

FIG. 20 is a is a graph illustrating the total and specular reflectance of the polished face of the stainless steel sample referred to in the various other figures;

### DEFINITIONS

AP—After polish

Belt—A commercially available polyester backing to which an abrasive grit has adhered. Size of belt (width) is not a factor in polishing metals.

Billy roll—A steel roll directly beneath and supporting the sheet steel being processed.

BP—Before polish

Color—The visual subjective appearance of the finish and through a clear coating applied over the faux SS polished material.

Coolant—A water soluble liquid applied to the belt at the polishing area. May have a minor effect on color of the finish. Coolant reduces friction from the abrasive grit laden belt, adds lubricity and contributes to a more shiny, reflective surface.

Finish—The final condition of a surface after the last phase of production. A rougher finish generally means a more dull, grayish appearance on stainless steel as may be produced by a more aggressive grit such as aluminum oxide or zirconium as compared to silicone carbide. An aggressive finish, i.e., rougher, may appear to have a more silvery gray “wild” appearance due to its rougher condition and a less aggressive finish produced by smaller grit, e.g., silicone carbide, may appear to have a softer satiny darker finish. A smoother surface will be more reflective than a rougher surface.

#1 to #5 finish—A conventional finish applied to stainless steel (SS) as accepted as an industry wide standard.

#3 Finish—100 mesh intermediate used where a semifinished polished surface is sufficient as further finishing operations will follow fabrication.

#4 Finish—120-150 mesh applied to a preconditioned sheet using abrasive belts and lubricating oils. A uniform commercial finish used extensively in food, dairy and pharmaceutical process equipment, or anywhere a smooth sanitary appearance is desired. Architectural quality sheets are produced from suitable starting material with knowledge of end use details.

#6 Finish—This is a dull satin finish having lower reflectivity than #4. It is produced by tampico brushing #4 finished sheets in a medium of abrasive particles and oil. It is used where dull matte finishes are necessary.

#7 Finish—This has a high degree of reflectivity, produced with fine abrasives to 320 grit then using a heavy lubricant or buff to bring the finish to a semi-mirror without removing the grit scratches. It is used chiefly for architectural trim and ornamental purposes or special industrial applications where a very fine finish is required.

#8 Finish—This is the most reflective of the AISI/ASM finishes. It is obtained by polishing with successively finer abrasives and buffing extensively with very fine buffing rouges. The surface is essentially free of grit scratches from preliminary grinding. This finish is most widely used for architectural applications, press plate mirrors and reflectors.

Finish specifications—Standard finishes provided by ASM/AISA specifications available at www.ssina.com.

Standard 3A Finish—150-240 grit finish

Sanitary Finish #3—80-100 grit finish, Ra </=40 microinches

Sanitary Finish #4—100-120 grit finish, Ra </=25 microinches

Pharmaceutical Finish #7—Buff Finish (mirror like)

Pharmaceutical Finish #8—Buff Finish (mirror like)

Grit—particles, an abrasive particulate material typically silicone, aluminum oxide or zirconium, applied to a polishing substrate such as a conventional abrasive polishing belt. Expressed in terms of numbers. e.g., 80/120/150/180/220 and so on. The smaller the number the larger the grain size of the particles and the rougher the surface roughness. An 80 mesh is rougher than a 120 mesh. Representative grits include silicone carbide, aluminum oxide, and zirconium. Silicone carbide is preferred for the present invention as it breaks down during use and is not too aggressive and is used for standard finishing and polishing. Aluminum oxide is used for light grinding and finishing in some cases. Zirconium is used for heavy grinding and stock removal. Suppliers of such grits include the following companies: 3M, Norton, Hermes, VSM and Sancap.

Head pressure—Pressure load Pressure of the polishing belt on the sheet metal being polished. Measured in terms of % load amperage on the belt drive motor. The higher amperage, the higher the pressure, the more aggressive the removal of material. Most motors idle at 20% load and polish stainless steel at about 75% load.

Head speed—The speed of the belt driven in the head by a drive roller.

Lightness L—Visual perception of the relative color and/or whiteness of a metal finish on a grayscale of black (0) to white (100).

Mesh—belt grit, e.g., 120-150 grit for silicone carbide grit.

Microinch—Root Mean Square divided by 1.11=one Microinch (one Microinch×1.11=RMS)

Polish—Providing an exterior surface finish to metal that changes its appearance by scratching the surface of the metal with fine grit to provide an aesthetic pleasing smooth and finished appearance to the exterior surface.

Polishing head—A set of two rolls about which a polishing belt is driven. One roll is motor driven and the other roll is an idler. The contact roll is motor driven and is the belt driver. The other roll is the idler roll and is used to track the belt and is belt driven.

Ra or RA—Arithmetical average surface roughness. See FIG. 5a. Roughness average is the arithmetic average height of the roughness irregularities measured from a mean line within a sample length L. This parameter may be commonly referred to as “the finish.”

$$Ra = \frac{1}{N} {\sum }_{l = 1}^{N} Yi$$

where Yi is the value of the profile deviations from the mean line over an evaluation length, not the sample length for ANSI

Rq-RMS—Root Mean Square surface roughness. See FIG. 5b. This is more sensitive to occasional peaks and valleys, making it a more valuable complement to Ra. While Ra is the arithmetic average, Rq is the geometric average height of the roughness component of irregularities measured from the mean line with the sampling length L. Rq is the square root of the arithmetic mean of the squares of profile deviations (Yi) from the mean line.

$$Rq = {( \frac{1}{N} {\sum }_{l = 1}^{N} {Yi}^{2} )}^{1 / 2}$$

where Yi is the value of the profile deviations from the mean line over an evaluation length, not the sample length for ANSI

Scratch—A linear impression, i.e., a groove, in a surface having a depth, length, width and relative orientation to a substrate length. Not important, per se, in defining a finish, which is best determined by surface roughness Ra or Rq as defined herein and as produced by and manifested by an array of scratches.

Scattered reflection—The angle of incidence of light differs from the angle of reflection.

Specular reflection—Reflection of light where the angle of incidence equals the angle of reflection.

SS—Stainless steel

Surface Finish Roughness—Measured in RMS (root mean square) or Ra (or RA) (average surface roughness). RMS is about 11% higher than Ra and typically is used as a measure of final finish rather than reflectivity to provide a quantified measure of the surface condition. The appearance of the surface finish to an observer is subjective and its appeal is correlated to surface roughness to assure repetitiveness.

Total reflectance—Specular and scattered reflection combined.

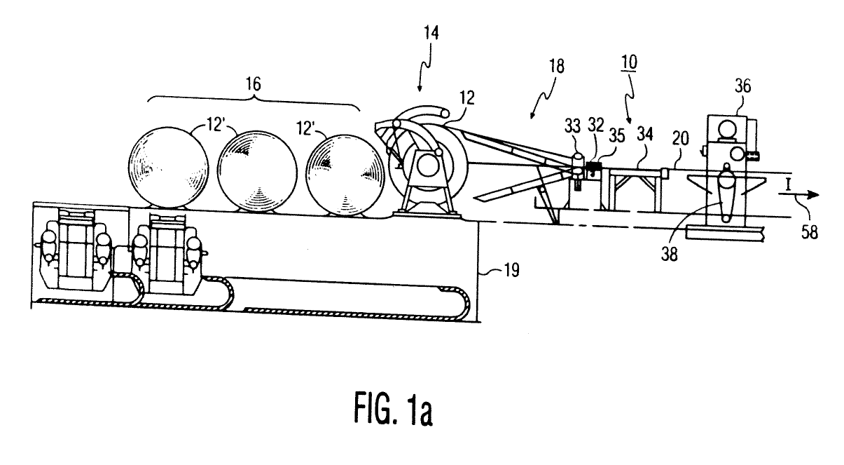

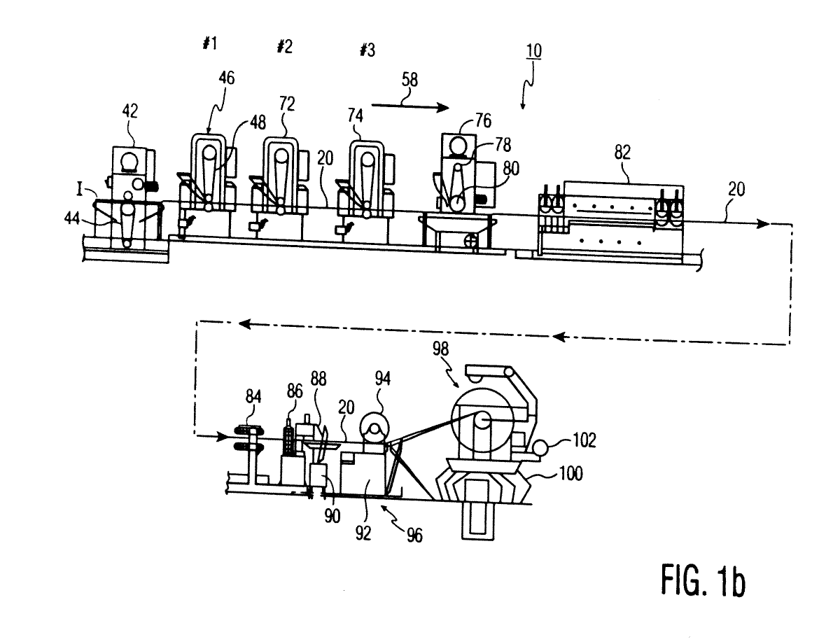

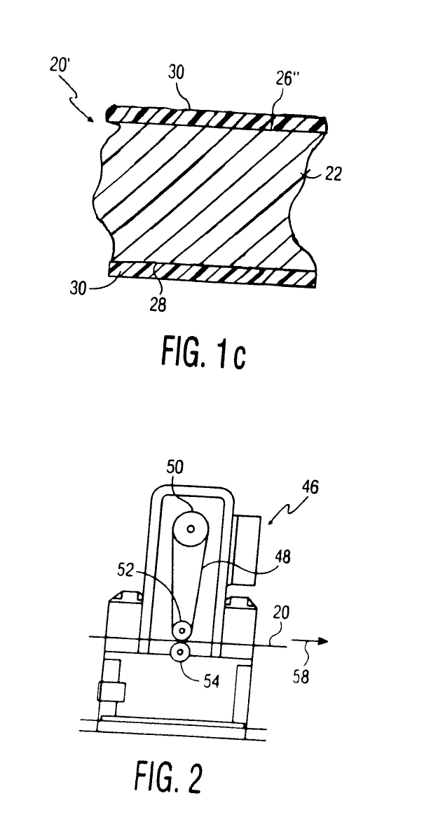

In FIGS. 1a and 1b, polishing apparatus 10 generally is conventional utilizing individual apparatuses that are conventional in the metal polishing art utilizing commercially available polishing belts that have associated grits. This however, is notwithstanding the fact that the combination of polishing belts, and corresponding mesh, belt pressure, speed, grit, time and depth of polishing and related polishing factors described hereinbelow are novel. The apparatus 10 comprises a plurality of polishing heads aligned in a linear array.

It is known, however, that every polishing apparatus comprising one or more polishing heads, even if otherwise identical from the same manufacturer, may produce a slightly different unique finish for a given set of variable factors. These factors, however, while being variable, can be adjusted in each apparatus to produce substantially the same finish. Those variables that exhibit the least influence over finish include the type of polishing head, two or four roll, belt size, i.e., its width, the oscillation parameters of the belt, and the type of coolant.

Each of the polishing heads in the apparatus 10 cooperates with each of the prior and subsequent heads in a linear sequence to produce the finished product. This sequence polishes the carbon ferrous steel sheet substrate material which is cold rolled steel. This material is of conventional gauge and width, as used to finish the exterior surfaces of major appliances such as refrigerators, ovens, clothes washers and dryers, dishwashers and others, or may used in vehicles or in architectural applications to provide the simulated appearance of SS.

Such appliances or applications fabricated with conventional SS sheet metal exteriors are relatively costly and popular. It is believed by providing faux SS with a carbon ferrous sheet steel substrate, which may be cold rolled steel as in the present embodiment, which is less costly than ordinary SS, the cost of the related appliances or other products can be reduced. This makes such appliances or other products available to a less affluent wider portion of the population.

In FIGS. 1a and 1b, the carbon ferrous cold rolled sheet steel 20 (CRS) is supplied from a coil 12 located at coil supply and uncoiling station 14. While coils are described as the form of the sheet material, it may be supplied in other forms, e.g., discreet sheets. Such sheets, which are not preferred for the present polishing embodiment, may be tack welded to each other during processing to form a continuous sheet. The coiled sheets are later, after polishing, are cut into discreet sheets (not shown) according to a particular implementation.

Other coils 12′ of carbon steel sheet material await polishing as replacements for coil 12 in an array 16 on support 19 when the polishing of the coil 12 is completed. The coils 12, 12′ are stacked in a column in the array 16.

Station 14 is a conventional twin cone uncoiler 18, which uncoils the sheet steel 20 from the coil 12. A conventional arrangement is provided (not shown) which moves a new coil 12′ into the uncoiler 18 at station 14 when the current roll 12 being processed is emptied of sheet steel. The sheet steel 20 is then pulled through the remainder of apparatus 10 by a coiling station at recoiler 98, FIG. 1b, at the other end of the apparatus 10 during polishing.

In FIG. 1a, downstream from the uncoiler 18 is an entry feed table 32 including an entry pinch roll 33 and an entry side guide 35. Downstream from the guide 35 is a weld table 34 for performing weld operations on the sheet material as deemed necessary. For example, the end edge of a sheet being processed is tack welded to the leading edge of the next to be polished coil sheet. Downstream from the weld table is a first polishing head 36. This head 36 may include an abrasive polishing belt 38, which belt includes an appropriate abrasive mesh attached, and which can be used to polish the underside surface 40 of the sheet steel 20 in a bottom surface polishing stage. However, in the present embodiment belt 38 is not in place or used. The underside of the sheet steel 20 is not polished in this embodiment.

Apparatus 10, FIGS. 1b and 2, includes representative first polishing head 46 having an abrasive polishing belt 48. Down stream from head 46 are polishing heads 72, 74 and 76 (not used). The head 46 has a two roll configuration as do heads 72, 74 which are substantially the same as head 46. FIG. 2 shows a more detailed illustration of the two roll configuration of representative head 46. The head 46 comprises an upper idler roll 50 and a small diameter lower driver roll 52, referred to as a contact roll in this art, which together drive the abrasive grit laden belt 48.

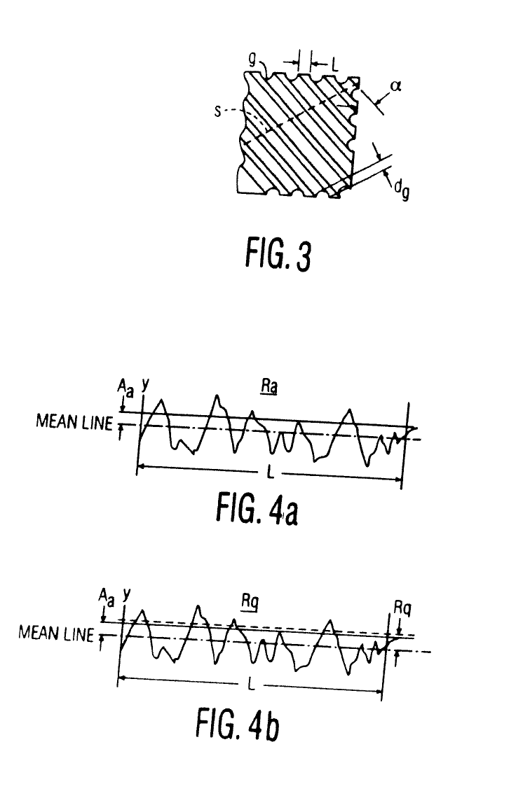

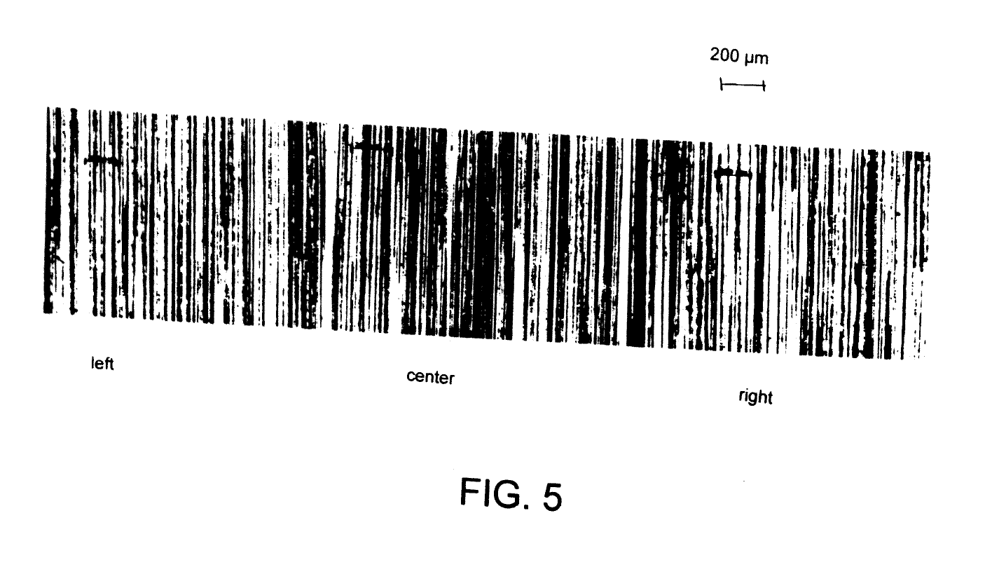

The roll 52, which is representative of other contact rolls used in the apparatus 10, is shown in FIG. 3. The roll 52 is made of rubber, and has the parameters noted in Table 2 below. The land in the Table is dimension L, the groove is groove g in FIG. 3, the angle of the grooves to a circumferential direction is α and the depth of the groove g is dimension d_{g}. The durometer is the hardness of the material and is significant in the final finish parameter affected by the roll. The significance of the groove g, its depth d_{g}, its-angle α and the width of the land L between the grooves, the roll diameter and its durometer is as follows.

The contact roll 52 is important in the finishing process. The contact roll serves the purpose of causing the coated belt to perform as if rigid and the abrasive particles on the belt to act as a group of sharp cutting teeth. It is an instrument that makes producing close and precision tolerances on thin carbon ferrous sheet steel possible. Also, other parameters of the finishing process can influence the finishing process performed by the abrasive belts. There may be no optimum contact roll design for any given application. However, a discussion of the causes and effects provide guidance to select the contact roll parameters is appropriate for the processing of the carbon sheet steel substrate material according to an embodiment of the present invention.

Some of the issues involved are whether the process is wet as in the present embodiment, or dry. The rate of stock removal, tolerances and finish requirements also play a part in specifying the contact roll parameters. In a wet process, the type of fluid or water soluble fluid, i.e., the coolant, and the chemical additives are beneficial to insure against deterioration and softening of the roll in use. The contact rolls need to be dynamically balanced at the RPM of use to insure minimum vibration or other undesirable results in an unbalanced roll.

Roll hardness is commonly measured by indentor type gauges that are calibrated in the “A” scale (ASTM D2240 and MIL-T-45186). The range of this scale is 0 to 100, with lower numbers (50 and lower) indicating a relatively soft condition and higher numbers (higher than 50) indicating a relatively hard roll. The durometer tolerance is typically +/−5. Soft durometers are used where stock removal is not of prime concern. Such rolls will conform to tapered or crowned sheet material without scalping and are also used to generate fine finishes. Harder durometers are used for heavy stock removal and thus are not desirable for the present process, which is directed to removing a minimum amount of material to polish the material to the desired finish.

The land to groove ratio is important to minimize and avoid chatter. Such ratios should not exceed 1:1 to minimize such problems. Grooves are preferably used to minimize contamination, i.e., oil, dirt etc. If the roll face becomes contaminated, objectionable marking and streaking of the roll surface (the land areas) may occur with the use of fine grit belts. The grooves preferably should be formed with a radius at the root to provide more support for the individual lands to prevent fatigue and subsequent premature breakage of the land areas.

The roll groove angle α, FIG. 3, has a possible range of 0 to 90°, but such a wide range is not used. The preferred range of the angle α is between a minimum value of about 8° and a maximum practical angle of about 60°. The 8° value provides a better finish than polishing with the 60° angle and is less aggressive. In the present process, however, the groove has a preferred angle of 45°. The 60° value is the maximum aggressive abrasion that results in a poor finish where that is acceptable and is not used with the present process for obvious reasons.

Any value less than 8°, e.g. 0° is not usable because striping or streaking occurs in the finish. More than 60°, for example 90°, is not usable because it results in excessive pounding, chatter, vibration and premature product destruction. The values between 0° and 8° increases the striping or streaking so that the finish is undesirable or values between 60° and 90° results in increased undesirable pounding, chatter, vibration as the value approaches 90°. For the present process, the roll groove angle is preferred at about 45° as shown in Table 1. As the need for uniform, mark free finishes increases as in the present embodiment, the angle of the grooves, which form serrations, decreases. No grooves or serrations are used where mainly polishing and fine finish generation is desired using soft 25-50 durometer contact rolls and where stock removal is minimal. As a result, to finish the steel substrate as described herein, a 50 durometer contact roll is used.

Contact rolls may be urethane as well as rubber compounds. A rubber compound is preferred for the contact rolls for the present apparatus 10. Hardness can range from 25 Shore A durometer (very soft) to 95 shore A durometer (very hard). The preferred durometer in the present process is shore A 50. The preferred grit is silicone particles. The contact roll among other factors in the process are described further in Table 1 below.

The belt 48, as all of the polishing belts used in the apparatus 10 polishing heads, three heads of the type shown in FIG. 2 being used in a linear array as in FIGS. 1a, 1b, has a width normal to the drawing figure of about 1.57 m (about 62 inches) whereas the sheet steel 20 substrate has a width of about or less than 1.22 m (48 inches). Directly beneath the lower roll 52 and beneath the sheet steel 20 being processed is a support billy roll 54. The relative vertical position of roll 54 is adjusted by a crank (not shown) to apply the pressure to the roll 52, the belt 48 and to the sheet steel 20 between the two rolls 52, 54 during polishing.

The head pressure is measured as a function of the load amperes drawn by the drive motor in the head. See Table 1 for exemplary pressures in the example shown. Roll 54 supports the sheet steel 20 as it is conveyed through the station 46 as well as applies pressure. Abrasive belt 48, laden preferably with silicone abrasive grit, but could be grit of other material as well, is driven by roll 50 via a motor (not shown).

In addition, an oscillating mechanism (not shown) oscillates, by a pivoting action, the upper drive roll 50 to displace the belt 48 at the drive and belt tracking roll 52. The roll 50 and the belt 48 are displaced in a direction normal to the feed direction 58 of the sheet steel 20 in and out of the drawing sheet perpendicular to the drawing sheet. The upper roll 50 is oscillated to thus reciprocate the belt 48 in directions normal to directions 58 in a range of about 0.635 cm to about 2.54 cm (about ¼ inch to about 1 inch). In this embodiment as shown in Table 1, the oscillation of roll 50 and the belt 48 normal to the drawing figure is about 0.635 cm (¼ inch). This motion transfers oscillating transverse motion amplitude to the belt 48 passing about the driven contact roll 52 of about 0.635 cm (¼ inch) in the direction normal to direction 58 for this embodiment. For other steel materials this value may have different values. Thus as the sheet steel 20 is pulled in direction 58, the belt 48 is oscillating in a normal direction at its sheet steel 20 contact region at the above noted 0.635 cm (¼ inch) amplitude. The values of grit size, belt speed, contact roll pressure, feed rate of the sheet material determine the finish characteristics on the sheet steel surface 26″, FIG. 1c, in cooperation with the downstream steps described below and in Table 1. However, the variables that have the most effect on the finish are the type of belt (the grit) and head pressure. Too much pressure or a too aggressive belt can readily polish too much substrate material. The oscillation period is one of the factors including line speed in direction 58 that sets the scratch lengths of the scratches produced on the sheet steel 20 by the particular abrasive grit on the belt 48.

Lighter gauge sheet material is run through the apparatus at a higher rate than thicker gauges. Heat is built up by the polishing process. Such heat can warp the sheet steel by inducing center buckling or edge waves. A coolant can prevent this action, but too much dwell of the steel sheet material at the belt, based on line speed in direction 58, FIG. 2, can pose a risk of too much material removal. This result of too much material removal is much more prevalent when run polishing is performed without a coolant. The final result can be achieved by trial and error within the skill of those of ordinary skill in this art. It is possible to run both thicker and thinner gauges at the same speed through the apparatus by careful attention to the parameters to provide a given appearance of the faux SS finish.

Belt widths for sheet steel of 48 inch widths or smaller may be 52 inches. In this embodiment, however, polishing belts of 62 inch width are employed. See Table 1. The length of a belt (Table 1) is a function of the number of rolls and their spacing in a given head. A belt typically has a seam diagonally across the belt width. This seam is non-parallel to and transverse a maximum amount to the contact roll 52 grooves g, FIG. 3, to preclude belt damage during operation.

The faster the line speed, i.e., the speed at which the sheet steel 20 is pulled by the take up recoiler 98 in direction 58, FIG. 1b, the longer the scratch, i.e., the longer the section of the sheet steel that is contact with the grits as it passes beneath the contact roll for a given oscillation period of the roll 50. The faster the head speed the shorter the scratch. The faster the oscillations of the belt, the shorter the scratch. The oscillations determine and thus provide scratches of limited length. Otherwise, without the oscillations, the scratches would be continuous and not desirable.

An adjustment apparatus (not shown) in head 46, FIG. 2, which is conventional as is the head 46 in general, adjusts the vertical position of the lower support roll 54 toward and away from the sheet steel 20. This applies the pressure of the conveyed substrate sheet steel 20 against the belt 48 at the position of the contact roll 52. The lower support roll 54 is referred to in this art as a “billy roll.” The amount of pressure on the belt 48 is measured by and setting the current amperage value drawn by the drive motor (not shown) for roll 50 drive motor. The current amperage drawn by the drive motors for the drive rolls such as roll 50 is correlated to pressure. Generally, a correlation table may be utilized to correlate drive motor amperage to pressure of the belt on the conveyed substrate being polished, the ferrous carbon sheet steel 20.

Different polishing lines may be set up with different polishing heads according to a particular steel composition and/or surface condition, i.e., surface roughness or defects, presence of rust etc. These polishing heads may be set up with different factors as discussed below in connection with Table 1. One set of polishing heads may be used for one finish and one steel composition and another set of polishing heads may be used for a different finish on a second different steel composition and so on.

The amplitude and frequency of the oscillations of the roll 50 of head is also settable by controls (not shown) and which controls are conventional. The belt 48, FIG. 2, oscillates at the oscillation rate (45 cycles/min) as detailed in Table 1.

Not shown in the figures is a coolant supply apparatus which supplies coolant to the belt at each polishing head before, at and after the polishing. The supply apparatus is conventional as supplied by the manufacturer of this machine. The coolant floods the polishing region between the belt and the sheet steel 20. The coolant may be Castrol Syntilo 9730, a product of Castrol company for a synthetic cutting fluid as used in the metal cutting art. The fluid comprises ethanol 2,2′,2″-nitrilotris (10-15% by weight), 1-propanol, 2-amino-2 methylborax (5-10% by weight) and 1,2-ethanediamine (0.1-1% by weight). An alternative coolant may be 4278 Chemtool, a product of the Chemtool company. This is a synthetic metal cutting fluid comprising ethanol 2,2′,2″-nitrilotris (10-15% by weight), hexanoic acid, 3,5,5-trimethy (5-10% by weight) and ethanol, 2-amino (1-5% by weight).

The apparatus 10, FIGS. 1a and 1b, includes three roll polishing heads 46, 72 and 74 of the representative type shown in FIG. 2. Some of the polishing heads such as heads 36, 42 and 76 depicted in FIGS. 1a and 1b are not in use in the present finishing process, but may be used in future or for other different processes, not described herein, employing the principles of the present invention.

In FIG. 1b, further two roll polishing heads 72 and 74, identical to head 46 are downstream from head 46. A further head 76 is similar to heads 46, 72 and 74 (not used in the present embodiment) is downstream from head 72. Head 76 has a relatively small drive roll 78 and a larger diameter contact roll 80.

Immediately downstream from head 76 is a conventional hot water rinse station 82. This station is followed by a drying station 84 for drying the sheet steel 20 being processed and followed downstream by an exit pinch roll 86. This is followed by an exit cropping shear station 88 and associated scrap buggy 90. Next in the line is an optional edge guide 92 and a turn roll 94 which deflects the sheet steel 20 to provide tension on the sheet steel 20 and exit feed table 96. These are followed by the recoiler 98 for coiling the processed sheet steel 20, a coil car 100 for receiving the coil of polished steel 20 and a kraft protective paper unwind unit 102.

The paper of unit 102 is impregnated to protect the sheet steel substrate. In one embodiment, the paper is called Uniwrap® a registered trademark of Daubed Cromwell LLC LTD of Burr Ridge, Ill. USA, for a natural kraft paper saturated with Daubed Cromwell MPI volatile corrosion inhibitor (VCI) formulation. This paper is for protecting ferrous/non-ferrous metals combinations including cadmium and zinc galvanized steel. This paper protects the steel substrate from moisture and other environmental elements.

The protective paper of unit 102 is interleaved with the coiled finished sheet steel 20 for protecting the polished finish surface and the sheet material from corrosion. The protective paper is also wrapped as a shroud about the finished coil.

The polished finished surface is later permanently protected by a clear or tinted polymer coating applied to the finished carbon steel substrate surfaces. The coiled finished material is shipped to this other facility for the polymer coating process.

In FIG. 1c, the clear, i.e., transparent or substantially transparent, protective coating 30, preferably a polymer in this embodiment, is applied over both sides of the sheet metal carbon ferrous steel substrate 22 and completely coats the sheet material on all surfaces. The polymer coating is sufficiently transparent so that the polished finish is visible through the coating, and for example, may be tinted to provide different colors such as bronze, silver and other coloring effects and so on to the polished material. The coating also may be translucent if desired. The coating 30 is applied by different commercially available independently operated manufacturing facility specializing in applying such coatings to sheet steel substrates typically to protect the substrate from the environment and to preclude corrosion.

The clear or tinted coating protects the metal sheet steel substrate and the polished finish from scratches, scuffs, fingerprints, and corrosion (carbon steel since it includes a ferrous material and thus contains iron, normally will rust unless otherwise protected).

If a conventional SS substrate finish is not acceptable on the processed SS sheet material, the sheet material can be run through the polishing operation again as the finish is being applied to the thicker base SS metal. In the present novel process, the same is also true, since the novel finish of the present embodiment is applied to a base ferrous carbon steel substrate. If the finish is not acceptable, the finish can be reapplied in one or more further passes as noted in Table I. Such multiple passes may not be desirable for certain substrates in some implementations where the thickness of the substrate material is critical. Such multiple passes might thus reduce the thickness to a value that is not acceptable, since the polishing operation of each pass removes a certain amount of the substrate material. In the present embodiment, the substrate thickness is reduced no more than about 0.0127 mm (0.0005 inches).

This is to be distinguished from the prior art wherein a separate metal coating is polished as shown in the copending application Ser. No. 11/221,300 noted in the introductory portion and in the McDevitt U.S. Pat. No. 6,440,582 also noted in the introductory portion. Such a coating limits the amount of material that can be removed before exposing the underlying substrate in an undesirable manner. Such a coating also is much softer than bare carbon cold rolled steel thus requiring substantively different polishing parameters than that of bare CRS carbon substrate as disclosed herein. In that case, there may not be enough coating material left to redo the finishing process requiring another coating to be applied, which is costly and defeats the purpose of providing a low cost faux SS finish.

In any case, the back side of the sheet steel 20 substrate, which is not normally polished, can be used to polish the same coil of steel substrate. This is normally is not necessary with a ferrous carbon steel substrate since the material is homogeneous throughout. Thus there is no need to process the otherwise unfinished back side of the sheet material.

TABLE 1
(EXAMPLE)
Processing Parameters for polishing a bare ferrous
carbon steel substrate to a simulate SS finish:

| | | |
|---|---|---|
| Substrate | | 0.635 mm (0.025 inches) |
| thickness | | |
| Polishing | | Hill Acme Two roll |
| heads | | FIG. 2 |
| Polishing | 1^{st} head | VSM* 981X or Sancap* |
| belt | | C786 60 grit Si Carbide |
| | | (S/C) |
| Belt | 2^{nd} head | R468 Norton* 80 grit S/C |
| Belt | 3^{rd} head | R468 Norton* 80 grit S/C |
| belt size | 1^{st} head | 24.41 cm × 49.6 cm |
| | | (62 inch × 126 inch) |
| belt size | 2^{nd} head | 24.41 cm × 49.6 cm |
| | | (62 inch × 126 inch) |
| belt size | 3^{rd} head | 24.41 cm × 49.6 cm |
| | | (62 inch × 126 inch) |
| line speed | | 25.908-32 m/min |
| | | (85-105 f/min) |
| number of | | 2 |
| passes** | | |
| Head | 1^{st} head | 1650 (3887 SFPM) |
| Speed RPM | labeled #1 in | (surface feet per min) |
| | FIG. 1b | |
| Head | 2^{nd} head | 1650 (3887 SFPM) |
| Speed RPM | labeled #2 in | (surface feet per min) |
| | FIG. 1b | |
| Head | 3^{rd} head | 1650 (3887 SFPM) |
| Speed RPM | labeled #3 in | (surface feet per min) |
| | FIG. 1b | |
| Head | 1^{st} head | 65-75 amps |
| Pressure | | |
| Amperage | | |
| Head | 2^{nd} head | 65-75 amps |
| Pressure | | |
| Amperage | | |
| Head | 3^{rd} head | 65-75 amps |
| Pressure | | |
| Amperage | | |
| Oscillation | stroke length | 0.250 inches (6.35 mm) |
| (all heads) | | |
| Oscillation | stroke rate | 45 cycles/min |
| (all heads) | | |
| Coolant | | Castrol Syntilo 9730 |
| Contact | Outside | 21.9 cm (8⅝ inches) |
| Rolls Roll | Diameter | |
| 52 FIG. 2 | (OD) | |
| | Durometer | 50 +/− 5 |
| | Land | 12.7 mm (0.5 inches) |
| | Groove | 9.53 mm (0.375 inches) |
| | Depth | 9.53 mm (0.375 inches) |
| | | radius bottom |
| | Degree of cut | 45° left hand helix |

*manufacturer of head
**When the coiled sheet carbon steel substrate is received from the steel mill manufacturing facility, it is coated in oil by the mill to protect the metal from corrosion. During the polishing operation, the grit belts are loaded with abrasive particles. The particles may become clogged due to the presence of the oil and may not function properly. This belt clogging prematurely requires one or more of the belts to be changed. When the belts on at least one head needs to be changed,the process must be stopped. When a belt is stopped to replace the defective belt, all three heads are stopped, creating unacceptable marks or defects on the sheet material at each head.

As a result, to remove these defects requires a second pass of the sheet substrate material through the entire apparatus of FIGS. 1a and 1b. The coolant does not create a clogging problem. Therefore, the substrate sheet steel material is run again in one further and complete pass through the process to remove the defects, but without the oil present on the finished surface. If the clogged belt condition does not occur during the initial pass through the process, a further polishing step pass is not required. When the clogging occurs in at least one belt requiring the belt to be changed, then two passes are required to produce an acceptable finish as was done with the example of Table 1.

When the polishing of the sheet material is completed, the material is wrapped in a corrosion protective impregnated paper interleaved with the sheet material. This occurs at recoiler 98, FIG. 1b, as the material is wound up into the finished product coil at the end of the process.

### Characteristics of Surface Finishes of Sheet Metal

Surface roughness—Measured with a profilometer and measures roughness average (Ra or RA). A reading of 45 or above may be considered rough and anything less is considered smooth. The lower the reading the smoother the finish.

Length of scratch—This is the average length of the scratch polished into the surface by an abrasive belt. This is typically measured manually.

Color—a comparative subjective description of the color of the finish.

Reflectivity—This measurement is not typically used for polished finishes because these finishes are generally not reflective (as in mirror finishes), but are more muted. Reflectivity is measured for the disclosed embodiment to assist in quantifying the finish. A reflectometer instrument measures reflectivity in gloss units (gloss units reflected into the instrument by the surface in question.). A reading of 500 gloss units or greater may be considered reflective where any value less than 500 gloss units might be termed muted. A glass mirror measures 1000 gloss units. Correlation of reflectivity to scratch length or scratch orientation is not known, but is measured herein. Scratch length or scratch orientation is intended herein to only quantify the mechanical finish characteristics associated with the faux coated stainless steel desired finish.

See Table 2 as follows for finish characteristic factors.

TABLE 2
Parameters which effect the final finish characteristics.

1. Surface roughness (RA) - Belt type, belt grit, contact roll and head
pressure
2. Length of Scratch - Line speed, head speed and oscillation of the belt
3. Color - coolant, belt type and belt grit
4. Reflectivity - Belt type, belt grit, contact roll, head pressure and coolant

The following Table 3 illustrates the quantifying of the values of Table 2 to provide approximate values.

TABLE 3

| | |
|---|---|
| Surface Roughness (Ra) | 10-20 |
| Length of Scratch | 9.53 to 12.7 mm (⅜-½ inch) |
| Color & visual | Dark stainless-like finish, tight |
| appearance (by eye) | grain pattern, uniform, scratches |
| | visible, shiny scratches |
| Reflectivity | See tables 9-12 |
| (gloss units) | |

The preferred finish applied to the ferrous carbon sheet steel 20 substrate may be about 80 mesh stainless steel finish. The finish can be different than this and provided in any desired industry standard SS finishes for which ASM/AISI specifications are written. See the introductory portion for further explanations of these finishes and also to the finishes described in the referred to Designer Handbook of Special finishes for Stainless Steel at the web site noted in the introductory portion. This document illustrates a wide variety of finishes that can be applied to stainless steel notwithstanding the standard finishes described above.

In polishing the sheet steel substrate, all preferred factors as follows contribute to the look of the finish. It should be also understood that the final look or appearance may also be affected by the protective coating.
Head belt drive roll RPM: 1650 rpm or 3887 SFPM
Grit size: Finishing is 80-120 and grinding with aggressive defect removal is 24-60 grit.
Feed Rate: 25.908-32 m/min (85-105 feet/min)
Belts: Three top side
Pressure Load: 65 to 75 amperes.

In the above tables, the line speed or material feed rate and head pressure are given in ranges. These ranges are due to the varying surface conditions of the raw steel sheet material being finished. Portions of the sheet material, which is supplied in coils of relative large lengths in the order of thousands of feet, may have a relatively “rough” surface, which requires increased abrasive belt dwell time to remove the undesirable unusually rough condition. In this case, the line speed may be slowed to 85 fpm and the pressure amperage raised to 75 to increase the belt pressure on the sheet material. If the sheet material exhibits a relatively “smooth” surface, the line speed is reduced to 85 fpm and the amperage reduced to 65. Of course if different materials exhibit different surface roughness these parameters may need further adjustment as well to different values than those given. Such adjustments are within the skill of those of ordinary skill in this art. The following is a description of the carbon steel substrate material:

Composition

The material composition was determined using an optical emission spectrometer.

TABLE 4
Composition - Corresponds with Grade 1005 carbon steel

| Element | | Results % | Spec Min % | Spec Max % |
|---|---|---|---|---|
| C | | 0.05 | 0.00 | 0.06 |
| Mn | = | 0.19 | 0.00 | 0.35 |
| P | | 0.005 | 0.000 | 0.040 |
| S | = | 0.007 | 0.000 | 0.050 |
| Si | | 0.02 | 0.00 | NS |
| Cr | | 0.05 | 0.00 | NS |
| Ni | | 0.05 | 0.00 | NS |
| Mo | < | 0.04 | 0.00 | NS |
| Cu | = | 0.05 | 0.00 | NS |
| Al | | 0.04 | 0.00 | NS |
| Fe | | Balance | Balance | Balance |

### Micro Hardness Method

Vickers Micro hardness was measure employing LECO Microhardness Tester LM700. with 25 gf applied load was used. Average of at least 10 indentations for stainless and 20 indications for carbon steel.

TABLE 5
Microhardness

| Sample | Stainless Steel | Carbon Steel |
|---|---|---|
| Vickers | 212.4 | 120 |
| St. Dev. | 12.11 | 9.24 |

### Sampling

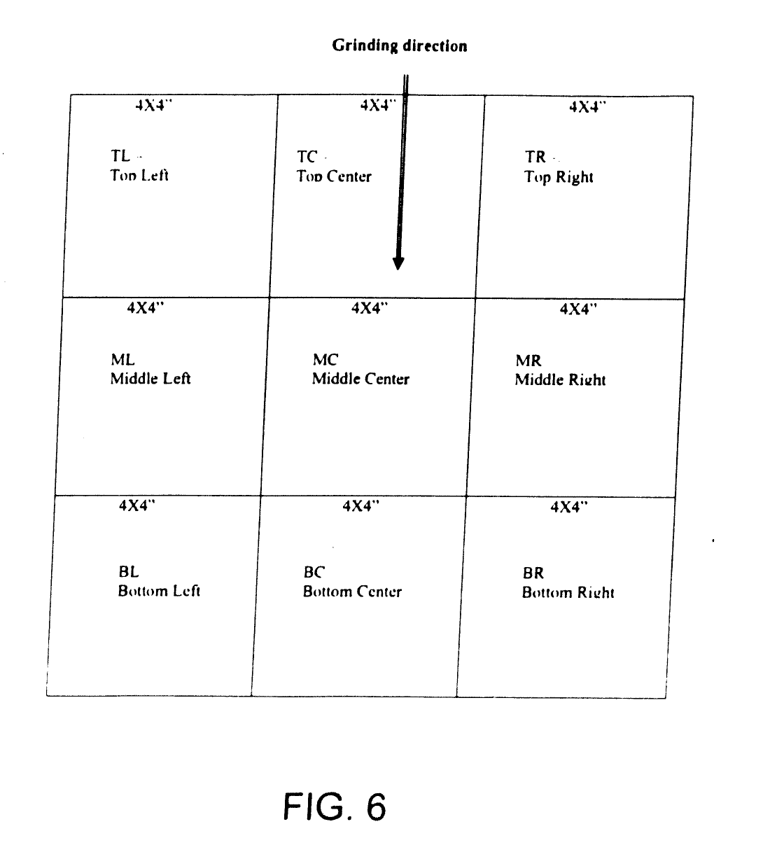

The most variation in properties one can expect across the surface perpendicular to the direction of grinding. The samples approximately 12.25″×12.25″ were cut into specimens as shown on FIG. 6. FIG. 5 shows the grooves created by the polishing process on the carbon steel substrate. The process produced grooves may be referred to herein as grinding marks or scratches interchangeably.

TABLE 6
Grinding (scratches) marks per inch

| | | | | | Stainl [symbol] |
|---|---|---|---|---|---|
| Sample | ML | MC | MR | Average | ste [symbol] |
| Lines per inch measured | 1336 | 1398 | 1320 | 1351 | 17 [symbol] |
| across the grinding grooves | | | | | |
| (2.54 cm) | | | | | |
| Width μm | 20 | 18 | 19 | 19 | 14 [symbol] |

[symbol]

indicates data missing or illegible when filed

### Surface Roughness

Equipment: Federal Pocket Surf Ill. Surface roughness (RA) was an average of four measurements for each position for the mild polished steel. An estimate of the range thus is about 10-20 RA.

TABLE 7

| Sample | ML | MC | MR | Average | SS |
|---|---|---|---|---|---|
| Surface Roughness (RA) | 17 | 16 | 16 | 16.33 | |
| Surface Roughness (RA) | 16 | 15 | 14 | 15 | |
| Surface Roughness (RA) | 17 | 20 | 17 | 18 | |
| Surface Roughness (RA) | 13 | 17 | 20 | 16.66 | |
| Surface Roughness (RA) | 18 | 17 | 15 | 16.66 | |
| Surface Roughness | 16.2 | 17 | 16.4 | 16.5 | 8.2 |
| (average) (RA) | | | | | |

(See FIG. 6 for ML, MC and MR terms definitions)

### Optical Properties

### Reflectivity.

All spectra were acquired on a Perkin Elmer Lambda 950 ultraviolet-visible spectrophotometer equipped with a Lab Sphere model 60MM RSA ASSY integrating sphere. Spectra were acquired from 320 to 860 nm and auto corrected to a reference standard provided with the sphere by the manufacturer. Two sample mount configurations are available with the sphere. Spectra were acquired with the samples mounted normal to the incident radiation, which allows for collection of diffuse reflectance and with the samples mounted at a small angle off norm for collection of both diffuse and specular reflectance. Specular reflectance was determined by difference between these spectra.

### Color and Gloss

Color Characteristics, L (lightness) a, b, CIE (white) and yellow (ASTM 313) were determined using X-Rite SP68 Sphere Spectrophotometer with dual beam optics system. Sample was placed under the target window of the spectrophotometer and three readings were taken and averaged. The unit was calibrated before each use using a reflection standard.

Following Table exhibits the results for color study on the coated carbon steel samples and stainless steel after polishing.

TABLE 8
Color Characteristics

| Color | MC | MR | ML | Average | Stainless I [symbol] |
|---|---|---|---|---|---|
| L | 81.75 | 82.04 | 82.07 | 81.95 | 82.8 |
| A | −0.27 | −0.12 | −0.17 | −0.19 | +0.15 |
| B | I | +0.16 | +0.19 | +0.17 | +4.63 |
| CIE | 58.98 | 59.55 | 59.41 | 59.31 | 38.18 |
| ASTM | 0.09 | 0.09 | 0.13 | 0.10 | 7.92 |
| E313 | | | | | |
| (yellow) | | | | | |

[symbol]

indicates data missing or illegible when filed

Lightness for the polished carbon steel substrate and stainless steel are close. The carbon steel is a little whiter reflecting all wave lengths more evenly.

Reflectance/Gloss

Gardner Micro-Tri-Gloss Meter was employed to determine

Reflectance/Gloss, Tables 9-12. The measurements were conducted at three different angles 20°, 60° and 85° across the grooves (scratches) Table 9. The average of three tests was determined Table 10. The measurements were conducted at three different angles 20°, 60° and 85° along or parallel to the grooves (scratches) Table 11. The average of three tests was determined Table 12. The light that is directed onto the surface of the test specimen is at a defined angle and the reflected light is measured photo-electrically. The meter was calibrated before each use using a calibration standard. Tables 9 and 10 are gloss variations when measured across the grinding grooves (12″×12″—Sample)

TABLE 9
Gloss Units Across the Grinding Grooves

| Sam- | | | | | | | |
|---|---|---|---|---|---|---|---|
| ple | Gloss | Reading 1 | Reading 2 | Reading 3 | Average | Min | Max |
| TL | 20° | 81.2 | 81.0 | 83.6 | 81.93 | 81.0 | 83.6 |
| | 60° | 103.6 | 113.8 | 108.4 | 108.60 | 103.6 | 113.8 |
| | 85° | 62.7 | 65.6 | 65.4 | 64.60 | 62.7 | 65.6 |
| ML | 20° | 80.0 | 84.4 | 81.2 | 81.90 | 80.0 | 84.4 |
| | 60° | 110.4 | 110.0 | 113.5 | 111.30 | 110.0 | 113.5 |
| | 85° | 65.5 | 64.4 | 64.9 | 64.90 | 64.4 | 65.5 |
| BL | 20° | 83.6 | 79.8 | 78.0 | 80.50 | 78.0 | 83.6 |
| | 60° | 105.7 | 102.8 | 104.4 | 10.43 | 10.4 | 105.7 |
| | 85° | 63.2 | 65.0 | 63.3 | 63.80 | 63.2 | 65.0 |
| TC | 20° | 83.3 | 80.2 | 81.7 | 81.70 | 80.2 | 83.3 |
| | 60° | 102.3 | 104.9 | 105.4 | 104.20 | 102.3 | 105.4 |
| | 85° | 62.0 | 66.8 | 66.0 | 64.93 | 62.0 | 66.8 |
| MC | 20° | 82.1 | 76.9 | 82.4 | 80.50 | 76.9 | 82.4 |
| | 60° | 108.2 | 103.4 | 100.5 | 104.00 | 100.5 | 108.2 |
| | 85° | 64.4 | 64.3 | 64.1 | 64.30 | 64.1 | 64.4 |
| BC | 20° | 79.8 | 83.8 | 81.7 | 81.80 | 79.8 | 83.8 |
| | 60° | 105.8 | 105.0 | 103.7 | 104.80 | 103.7 | 105.8 |
| | 85° | 66.2 | 65.2 | 65.8 | 65.70 | 65.2 | 66.2 |
| TR | 20° | 83.2 | 78.6 | 82.4 | 81.40 | 78.6 | 83.2 |
| | 60° | 102.6 | 108.9 | 113.6 | 108.40 | 102.6 | 113.6 |
| | 85° | 66.9 | 69.3 | 66.7 | 67.60 | 66.7 | 69.3 |
| MR | 20° | 85.0 | 84.3 | 79.7 | 83.00 | 79.7 | 85.0 |
| | 60° | 113.6 | 107.9 | 106.9 | 109.50 | 106.9 | 113.6 |
| | 85° | 67.7 | 66.4 | 65.7 | 66.60 | 65.7 | 67.7 |
| BR | 20° | 77.1 | 81.5 | 82.4 | 80.30 | 77.1 | 82.4 |
| | 60° | 101.8 | 105.5 | 108.3 | 105.20 | 101.8 | 108.3 |
| | 85° | 64.6 | 66.2 | 66.8 | 65.87 | 64.6 | 66.8 |
| SS | 20° | 54.1 | 48.3 | 46.4 | 49.60 | 46.4 | 54.1 |
| | 60° | 79.7 | 83.9 | 87.6 | 83.70 | 79.7 | 87.6 |
| | 85° | 95.9 | 96.9 | 95.5 | 96.10 | 95.5 | 96.9 |

See FIG. 6 for definitions of MC, MR, ML

TABLE 10
Gloss Units Across the Grinding Grooves

| | Average | Min | Max | Std Dev |
|---|---|---|---|---|
| 20° | 81.5 | 76.9 | 85.0 | 2.25 |
| 60° | 106.8 | 100.5 | 113.8 | 3.90 |
| 85° | 65.5 | 62.0 | 69.3 | 1.52 |

TABLE 11
Gloss units parallel to the grinding grooves

| Sample | Gloss | Reading | Reading | Reading 3 | Average | Min | Max |
|---|---|---|---|---|---|---|---|
| TL | 20° | 159 | 161.9 | 161.7 | 160.9 | 15 | 16 |
| | 60° | 0 | 0 | 0 | 0.0 | 0.0 | 0.0 |
| | 85° | 108 | 109.3 | 101.9 | 106.4 | 10 | 10 |
| ML | 20° | 156 | 159.1 | 152.3 | 155.9 | 15 | 15 |
| | 60° | 0 | 0 | 0 | 0.0 | 0.0 | 0.0 |
| | 85° | 110 | 104.9 | 105.4 | 106.9 | 10 | 11 |
| BL | 20° | 151 | 153.3 | 158.4 | 154.4 | 15 | 15 |
| | 60° | 0 | 0 | 0 | 0.0 | 0.0 | 0.0 |
| | 85° | 101 | 104.5 | 110.6 | 105.7 | 10 | 11 |
| TC | 20° | 161 | 160.5 | 160.8 | 160.8 | 16 | 16 |
| | 60° | 0 | 0 | 0 | 0.0 | 0.0 | 0.0 |
| | 85° | 110 | 110.4 | 110.2 | 110.2 | 11 | 11 |
| MC | 20° | 149 | 152.3 | 159 | 153.6 | 14 | 15 |
| | 60° | 0 | 0 | 0 | 0.0 | 0.0 | 0.0 |
| | 85° | 109 | 108.9 | 110.9 | 109.7 | 10 | 11 |
| BC | 20° | 157 | 161.4 | 158.5 | 159.3 | 15 | 16 |
| | 60° | 0 | 0 | 0 | 0.0 | 0.0 | 0.0 |
| | 85° | 110 | 109.3 | 110.1 | 109.9 | 10 | 11 |
| TR | 20° | 165 | 160.3 | 166.9 | 164.3 | 16 | 16 |
| | 60° | 0 | 0 | 0 | 0.0 | 0.0 | 0.0 |
| | 85° | 107 | 103.7 | 101.6 | 104.2 | 10 | 10 |
| MR | 20° | 159 | 164.4 | 165.3 | 163. | 15 | 16 |
| | 60° | 0 | 0 | 0 | 0.0 | 0.0 | 0.0 |
| | 85° | 110 | 110.3 | 109.9 | 110.2 | 10 | 11 |
| BR | 20° | 158 | 153.6 | 156.8 | 156.3 | 15 | 15 |
| | 60° | 0 | 0 | 0 | 0.0 | 0.0 | 0.0 |
| | 85° | 110 | 109.2 | 108.3 | 109.2 | 10 | 11 |
| SS | 20° | 101 | 96.1 | 94.9 | 97.6 | 94. | 10 |
| | 60° | 0 | 0 | 0 | 0.0 | 0.0 | 0.0 |
| | 85° | 121 | 122.3 | 120.5 | 121.5 | 12 | 12 |

TABLE 12
Average Values Parallel to grinding grooves

| | Average | Min | Max | Std Dev |
|---|---|---|---|---|
| 20° | 158.72 | 149.5 | 166.9 | 4.47 |
| 60° | 0.00 | 0.0 | 0.0 | 0.00 |
| 85° | 108.03 | 101.6 | 110.9 | 3.00 |

The zero reading for 60 deg test indicates that the reflected light for 60 degrees of illumination of the base surface does not reach the 60 degree reflected light detector located opposite the source in any detectable amount. As an illustration just for understanding the phenomenon, consider an array of grooves with walls of the grooves at 60 degrees to the base surface. Light from the source illuminating base surface at 60 degrees will be perpendicular to the wall surface. In this case, in an ideal situation, all the light that reaches the wall is reflected back to the source. Very little or no light will reach the detector placed at 60 degrees to the base surface opposite the 60 degree source.

### Total, Diffused and Specular Reflectance

### Reflectivity (Reflectance)

All spectra were acquired on a Perkin Elmer Lambda 950 ultraviolet-visible spectrophotometer equipped with a Lab Sphere model 60MM RSA ASSY integrating sphere. Spectra were acquired from 320 to 860 nm and auto corrected to a reference standard provided with the sphere by the manufacturer. Two sample mount configurations are available with the sphere. Spectra were acquired with the samples mounted normal to the incident radiation, which allows for collection of diffuse reflectance and with the samples mounted at a small angle off norm for collection of both diffuse and specular reflectance. Specular reflectance was determined by difference between these spectra.

Diffuse reflection is the reflection of light from an uneven or granular surface such that an incident ray is seemingly reflected at a number of angles. It is the complement to specular reflection. If a surface is completely non-specular, the reflected light will be evenly spread over the hemisphere surrounding the surface.

Specular reflection in contrast is the perfect, minor-like reflection of light (or sometimes other kinds of wave) from a surface, in which light from a single incoming direction is reflected into a single outgoing direction.

Total, diffused and specular reflectivity for the polished carbon steel samples were determined and compared to a polished stainless steel sample. The carbon steel side opposite the polished side was not measured due to unknown surface conditions that modified the surface.

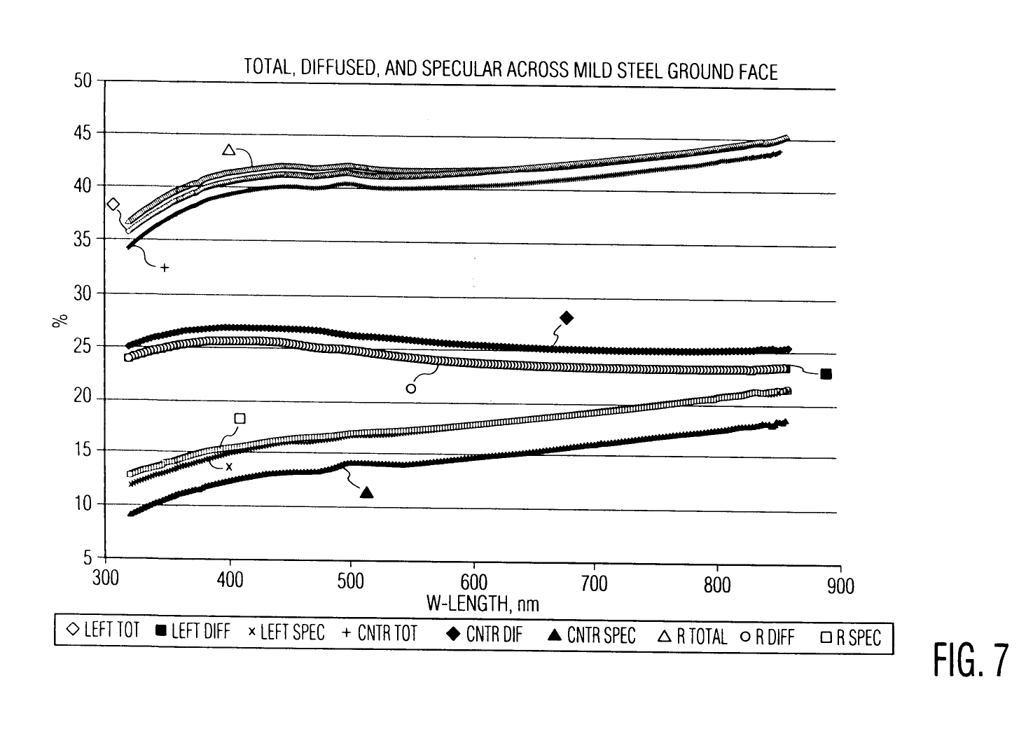

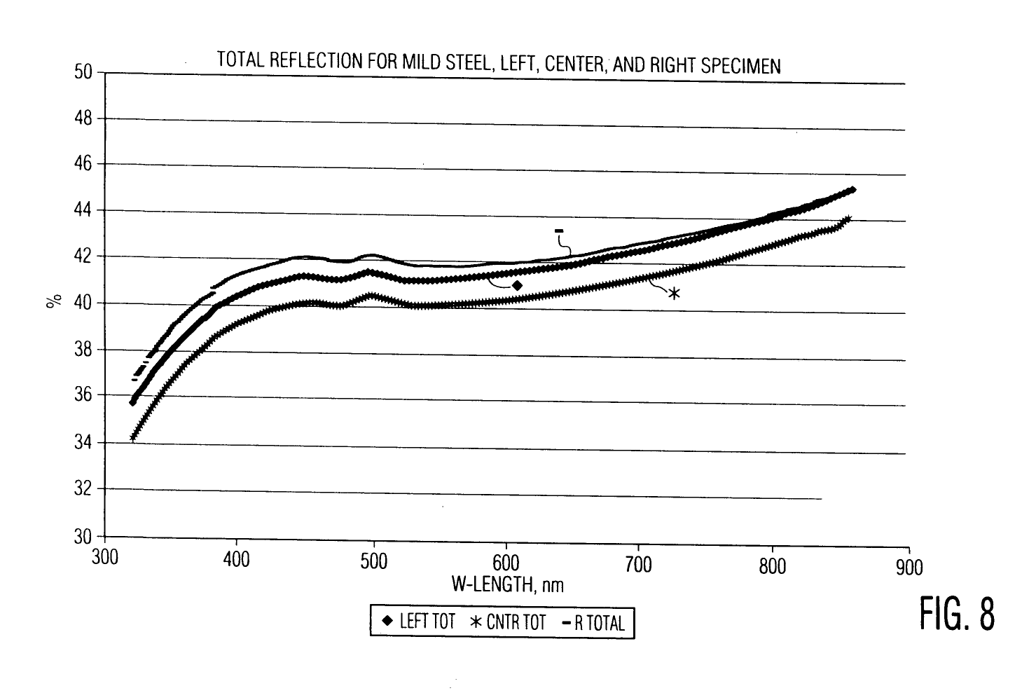

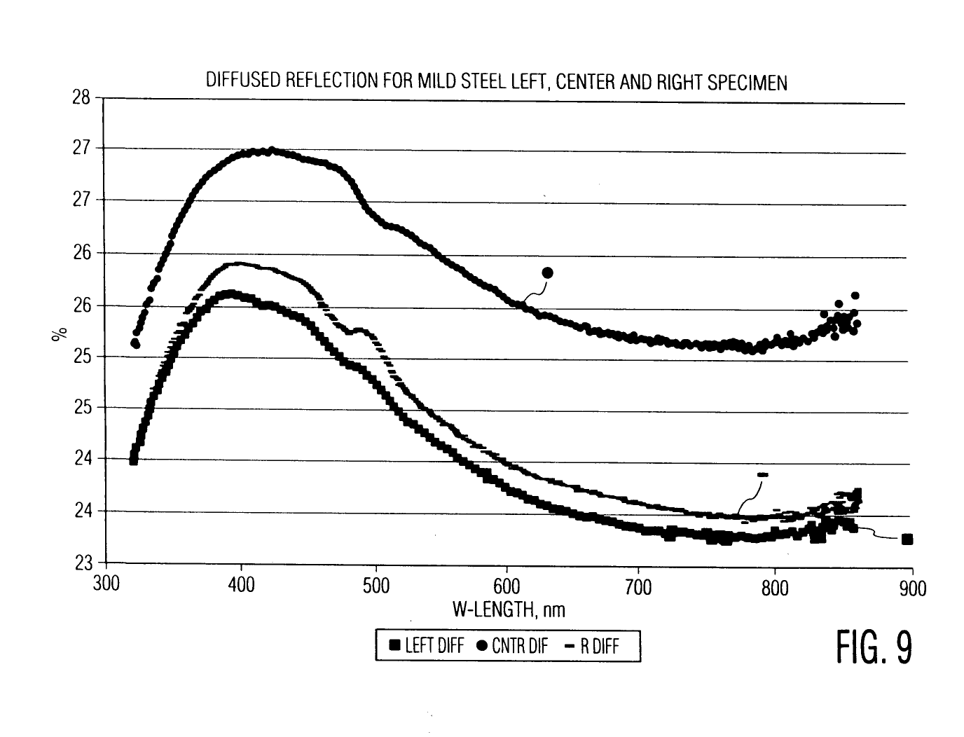

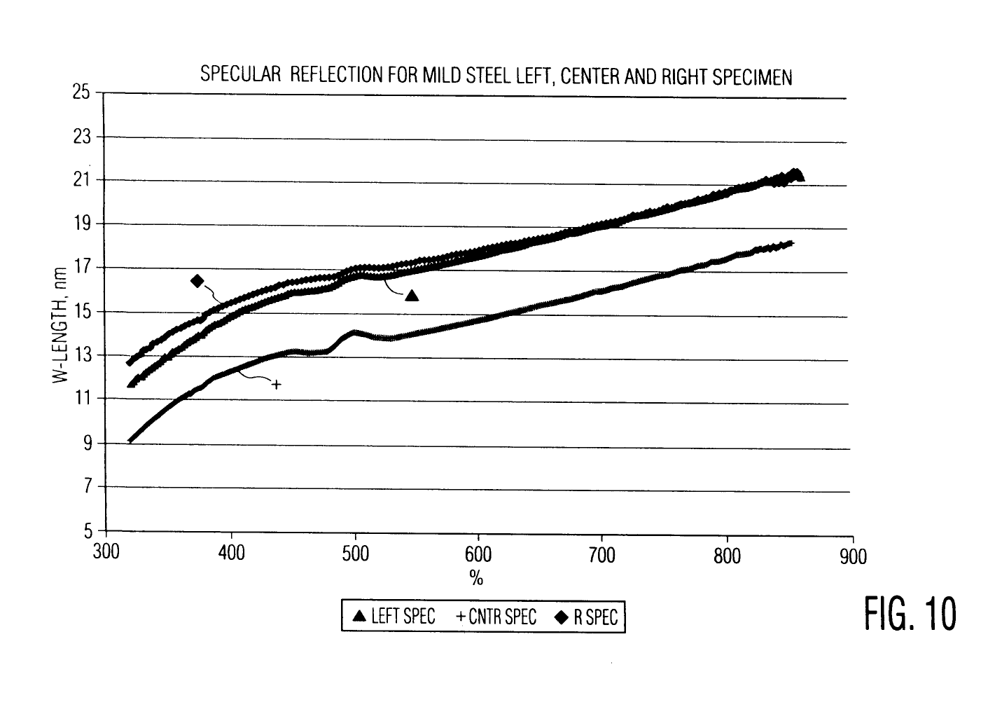

FIGS. 7-10 show reflectance of the polished carbon steel samples as measured, showing total, diffused and specular reflections for the carbon steel sample and in certain of these figures, for the carbon steel polished sample (referred to in the drawings as mild steel as known in the metals art) left, middle and right locations across the sample as per FIG. 6. FIGS. 8-10 are amplifications of the different line portions of the graph of FIG. 7 to show the results more clearly.

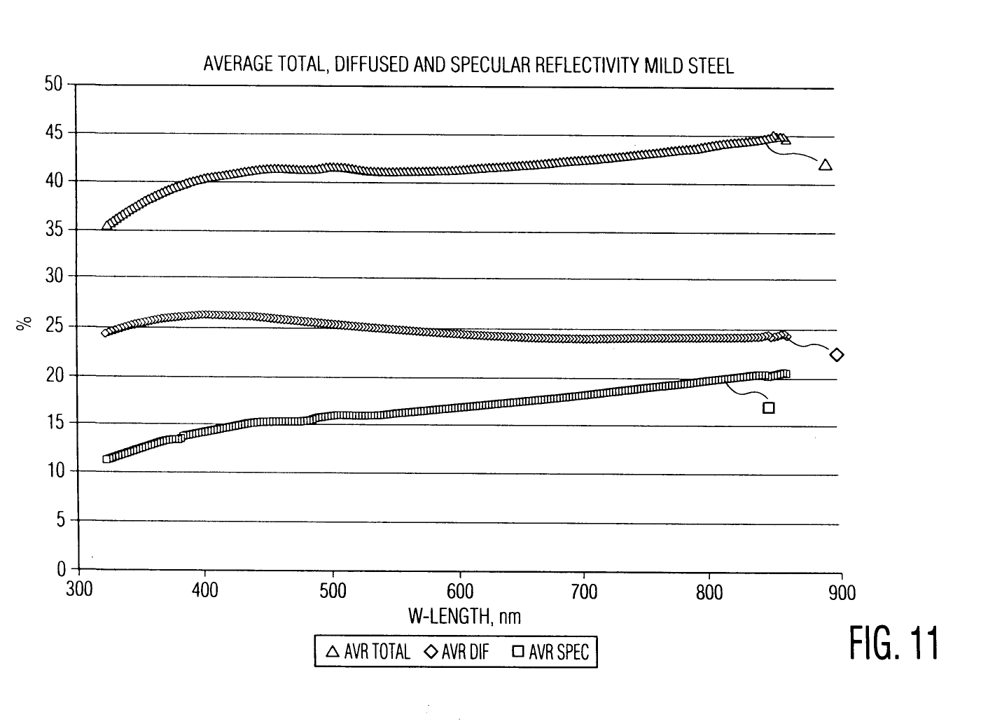

FIG. 11 shows the average total diffused and specular reflectance for the polished carbon steel samples as measured. It shows total reflection, diffused reflection and specular reflections left, middle and right location across the sample of FIG. 6.

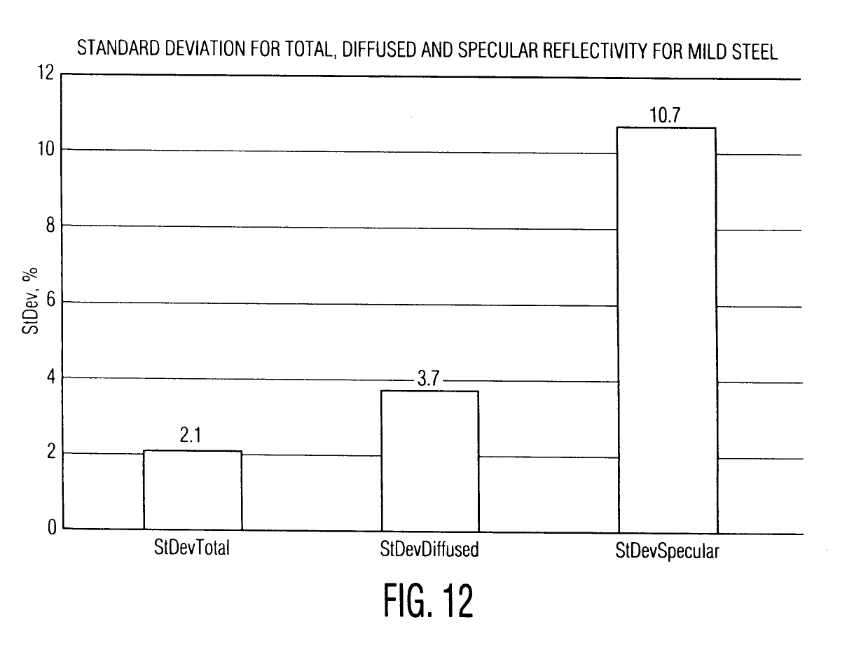

FIG. 12 shows the standard deviations for total, diffused and specular components of the polished carbon steel sample.

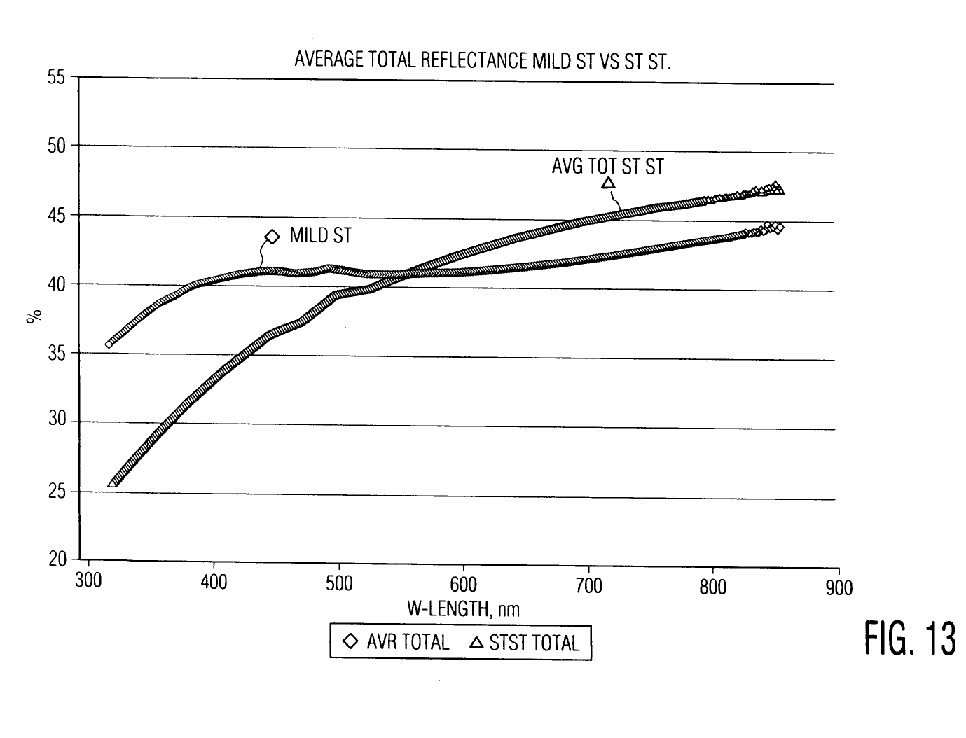

FIG. 13 compares average total reflectance of the polished carbon steel sample with stainless steel. They are comparable in value, but the carbon steel curve is flatter confirming the color test results that show that carbon polished (mild) steel is whiter.

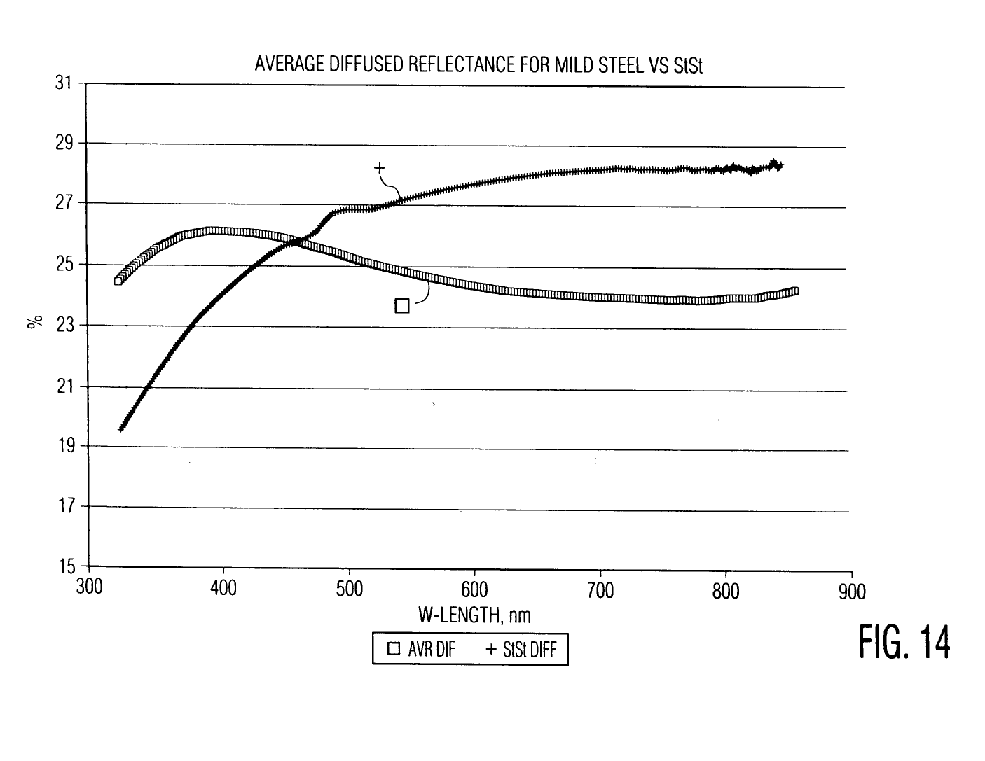

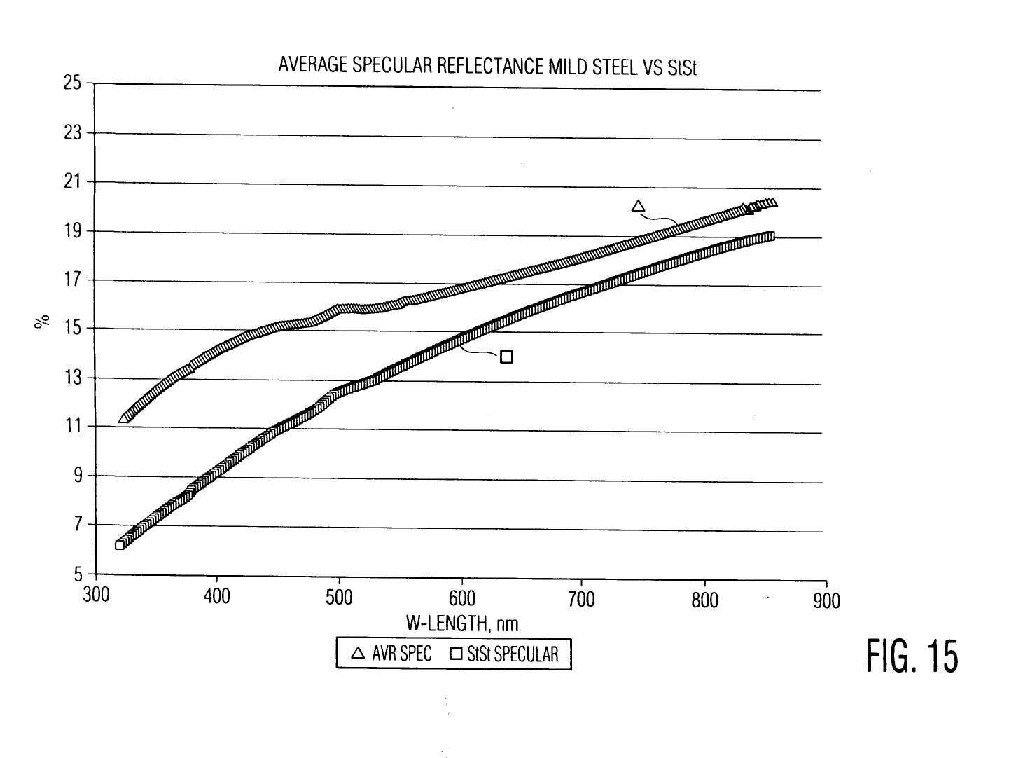

FIGS. 14 and 15 show similar behavior for diffused and specular reflectance and demonstrate close values with specular and diffused components for stainless steel.

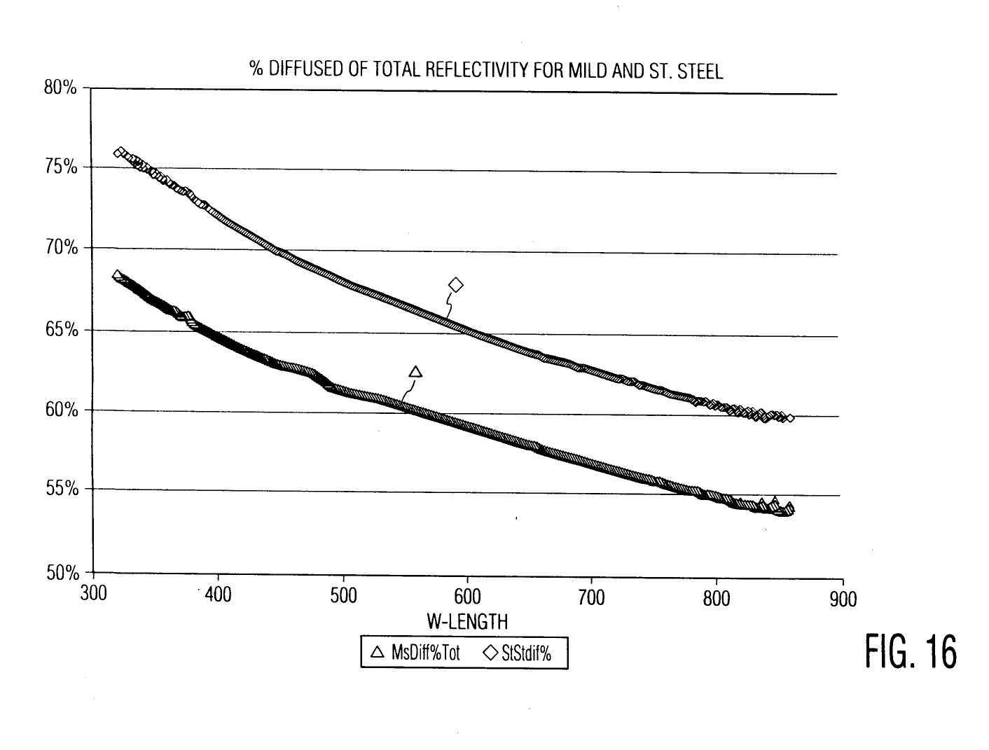

FIG. 16 shows that diffused reflection for stainless steel is a higher fraction of total reflection compared to mild steel. Possible effect of a higher number of grooves for stainless compared to Mild steel.

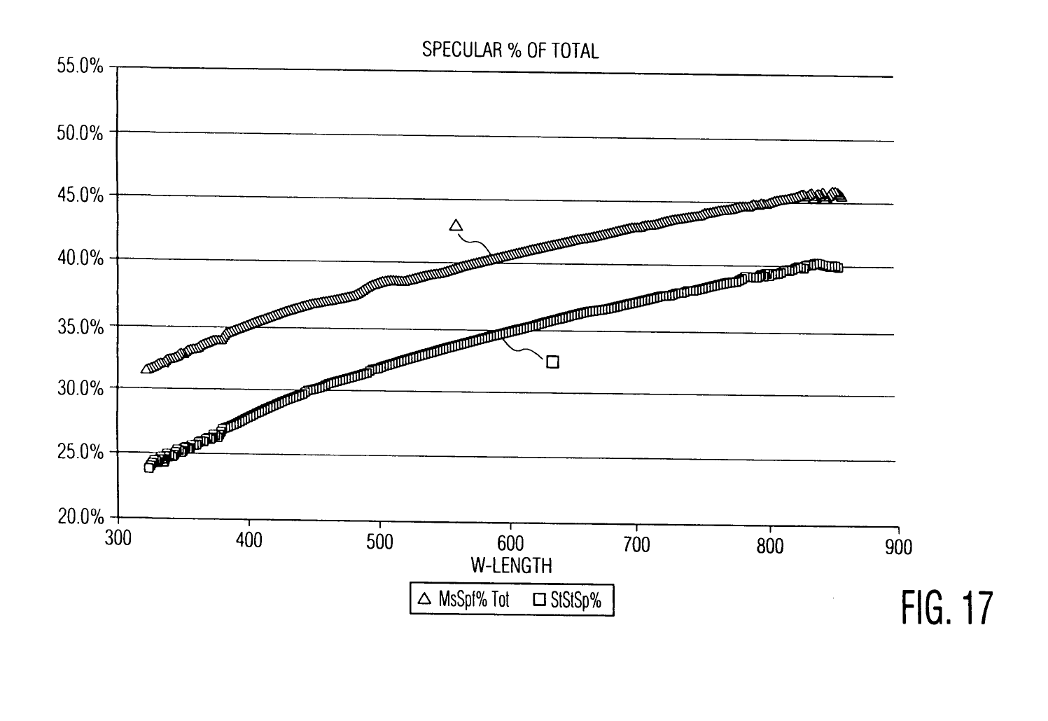

FIG. 17 compares the carbon steel polished sample (MsSpf-triangle) to the stainless steel sample and shows that the carbon steel exhibits a higher total specular reflection similar to the result shown in FIG. 16.

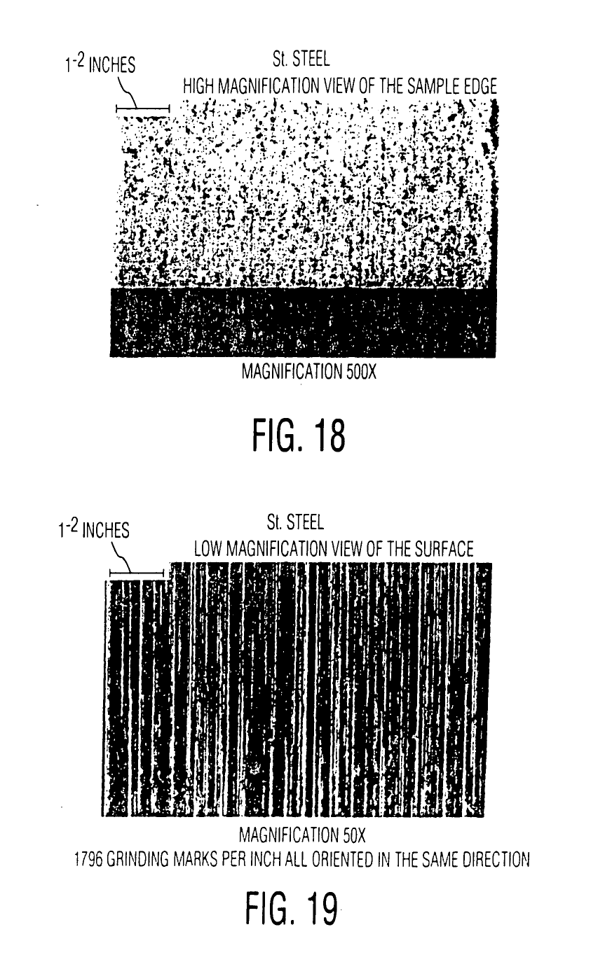

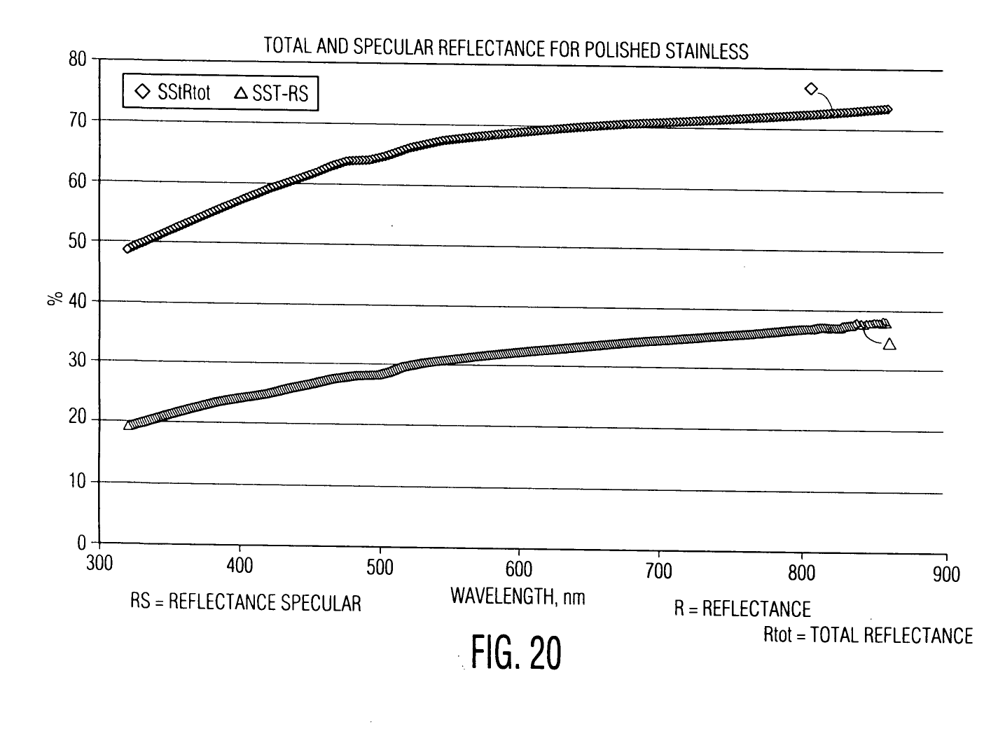

FIGS. 18 and 19 are respective cross section photographs taken at 500× and top plan view taken at 50×. Compare this figure with FIG. 5 and appear to be similar. FIG. 20 shows the total and specular reflectance for polished stainless steel.

From the forgoing the following observations can be made.
1. The optical characteristics of the polished surface of the carbon steel are close to the optical characteristics of the stainless steel.
2. The diffused reflection for stainless comprises a higher portion of its total reflectivity.
3. The increase in the diffused reflectivity portion increases with the degree of the polishing of the surface.
4. Increased whiteness of the polished carbon steel compared to stainless steel is caused by the difference in the alloy composition (presence of nickel in stainless)
5. Casual observation of the polished carbon mild steel sample visually mimics stainless steel

It will occur that modifications may be made to the disclosed embodiments by one of ordinary skill. The disclosed embodiments are given by way of example and not limitation. For example, the exemplary descriptions herein are of the processes used to reproduce a simulated faux SS finish on a given composition of a cold rolled ferrous carbon sheet steel.

In addition, abrading processes, not shown or described specifically herein, but utilizing the apparatus disclosed herein or similar apparatus may be used with grit loaded belts to provide faux standard or non-standard SS finishes. It is intended that the scope of the invention be defined by the following claims appended hereto.

What is claimed is:

1. A faux polished stainless steel sheet comprising:
a ferrous carbon steel sheet material substrate; and
an abrasive grit belt polished finish on the exterior surface of the sheet material, which finish simulates polished stainless steel.

2. The faux stainless steel sheet of claim 1 wherein the material has a grit polished surface roughness in the range of 10-20 RA, scratches having a length of about 9.5 to 12.7 mm (⅜ to ½ inches), and a reflectivity of about 80 to about 115 gloss units across the scratches and about 100 to about 170 gloss units parallel to the scratches wherein a gloss unit is the ratio of light specularly reflected to the total light reflected wherein specularly reflected light is one wherein the angle of incidence equals the angle of reflection.

3. The faux stainless steel sheet of claim 1 wherein the grit polished surface exhibits substantially parallel scratches and has a reflectivity in the range of about 80 to about 115 gloss units across the scratches and about 100 to about 170 gloss units parallel to the scratches wherein a gloss unit is the ratio of light specularly reflected to the total light reflected wherein specularly reflected light is one wherein the angle of incidence equals the angle of reflection.

4. The faux stainless steel sheet of claim 1 wherein the grit polished surface has substantially parallel scratches having a length of about 9.5 to about 12.7 mm (about ⅜ to about ½ inches).

5. The faux stainless steel sheet of claim 1 wherein the grit polished surface has roughness in the range of about 10-20 RA.

6. The faux stainless steel sheet of claim 1 wherein the carbon sheet steel material has a thickness of about 0.635 mm (about 0.025 inches).

7. The faux stainless steel sheet of claim 1 wherein the grit polished finish is produced by a Si carbide grit particle loaded 80 mesh belt and has the visual appearance of a commercially defined abraded polished stainless steel finish comprising about 80 mesh wherein the term mesh refers to a belt grit value.

8. The faux stainless steel sheet of claim 1 wherein the grit polished finish is formed by abrasion of the ferrous carbon steel sheet outer surface on one side of the sheet to form scratches in the outer surface.

9. The faux stainless steel sheet of claim 1 including a protective polymer coating over at least the grit polished surface wherein the polished surface is visible through the coating.

10. The faux stainless steel sheet of claim 1 including a protective polymer coating over the entire sheet including the grit polished surface wherein the polished surface is visible through the coating.

11. A method of producing a faux stainless steel sheet comprising polishing a ferrous carbon steel sheet material substrate surface with at least one abrasive particle loaded grit belt to form a surface finish that simulates a polished stainless steel finish on that surface.

12. The method of claim 11 wherein the polishing step comprises forming scratches in the surface with scratches having a length of about 9.5 mm (⅜ inch).

13. The method of claim 11 wherein the polishing step comprises polishing the surface to form substantially parallel scratches in the surface having a reflectivity in the range of about 80 to about 115 gloss units across the scratches and about 100 to about 170 gloss units parallel to the scratches wherein a gloss unit is the ratio of light specularly reflected to the total light reflected wherein specularly reflected light is one wherein the angle of incidence equals the angle of reflection.

14. The method of claim 11 wherein the polishing step comprises engaging a Si carbide particle loaded grit belt with the surface in transverse oscillations having an amplitude of about 6.35 mm (¼ inch) at 45 cycles per minute and at a sheet material feed rate of about 25.908-32 m/min (85-105 f/min).

15. The method of claim 11 including the step of forming an appearance of a commercially defined abraded polished stainless steel finish with a Si carbide particle loaded grit belt comprising about 80 mesh wherein the term mesh refers to the belt grit value.

16. The method of claim 11 including providing the surface with a surface roughness of about 10-20 RA.

17. The method of claim 11 including coating the polished substrate with a polymer coating to protect the underlying substrate from corrosion wherein the polished finish is visible through the coating.

18. The method of claim 11 including the step of forming the substrate to about 0.635 mm (0.025 inches) thick.

19. The method of claim 11 wherein the polishing step comprises removing up to about 0.0127 mm (0.0005 inches) of material from the substrate thickness.

20. The method of claim 11 wherein the polishing step comprises coating at least the polished surface with a coating that is sufficiently transparent so that the polished surface is visible through the coating.
